(19) United States
(12) Patent Application Publication
(10) Pub. No.: US 2011/0199475 A1
(43) Pub. Date: Aug. 18, 2011

(54) CUSTOMER SERVING SYSTEM

(75) Inventor: CHIA-CHUN TSOU, TAIPEI COUNTY (TW)

(73) Assignee: UTECHZONE CO., LTD., TAIPEI COUNTY (TW)

(21) Appl. No.: 12/945,008

(22) Filed: Nov. 12, 2010

(30) Foreign Application Priority Data
Feb. 12, 2010 (TW) 099104987

(51) Int. Cl. H04N 7/18; G06F 3/041

(52) U.S. Cl. 348/78; 345/173; 348/143; 348/E07.085

(57) ABSTRACT

A customer serving system comprises a detection device, a display device and a control unit. The detection device is arranged for detecting customers within a monitoring area. The display device is coupled to the detection device for starting to display a greeting message, when the customers coming to the monitoring area are detected. The display device has an interactive panel for confirming demands of the customers and handling questions after greeting the customers. The control unit is coupled to the display device for displaying information on the interactive panel based on requests of the customers. The customer serving system can greet the customers, when service personnel are temporarily absent. The customer serving system can provide an effective response in real time in accordance with demands of the customers. After detecting the service personnel, the customer serving system can be switched to allow the service personnel to serve the customers.

### BACKGROUND OF THE INVENTION

1. Field of the Invention

The present invention relates to a customer serving system, and more particularly to a customer serving system that greets customers to provide expositions and entertainments when service personnel are absent.

2. Description of the Related Art

For small scale hotels with less people such as commercial hotels, motels, etc, these hotels provide services with relatively low prices, such that market demands are gradually increased. Although these hotels are in relatively small-scale operations, these hotels still require service personnel to await orders for 24 hours in order to satisfy customers arriving and coming in or going out at night. In spite of very few businesses, the work efficiency may not be well enough since these service personnel must work for a long time.

When the service personnel are near counters, the demands of the customers can be seen and handled. For example, when customers request services, the service personnel can reply to them immediately. However, when there are few customers at night or in the morning, the service personnel may be absent from the counters. The situation of the fewer customers in the hotels is unable to be controlled, and may not be handled immediately with respect to the greeting.

In small scale stores with less cashiers such as convenient stores, the same problem as well as the small scale hotels exists. Cashiers must be absent from the counter temporarily due to inventory replenishment, such that customers are unable to be greeted one by one, and bill paying service may not be dealt with immediately. Nevertheless, if the cashiers are allowed to wait for bill paying service for a long time in the convenient stores, the expenses afforded by the convenient stores are relatively increased to generate a difficulty in economics.

### SUMMARY OF THE INVENTION

In view of the shortcomings of the prior art, the inventor of the present invention based on years of experience in the related industry to conduct extensive researches and experiments, and finally developed a customer serving system to prevent customers from being bored while waiting for the service, and to provide expositions and entertainments, thereby enhancing customers' satisfaction.

Therefore, it is an objective of the present invention to overcome the aforementioned shortcoming and deficiency of the prior art by providing a customer serving system.

To achieve the foregoing objective, the customer serving system of the present invention comprises a detection device, a display device and a control unit. The detection device is arranged for detecting customers within a monitoring area. The display device is coupled to the detection device for starting to display a greeting message, when the customers within the monitoring area are detected. The display device can comprise an interactive panel for confirming demands of the customers and handling questions after greeting the customers. The control unit is coupled to the display device for displaying information on the interactive panel based on requests of the customers.

According to a preferred embodiment of the present invention, the detection device can include a sensor arranged for performing detection.

According to a preferred embodiment of the present invention, the detection device can include a camera for continuously capturing images within the monitoring area. The detection device further includes an arithmetic unit coupled to the camera to recognize the appearance of the customers shown on the images.

According to a preferred embodiment of the present invention, the interactive panel may be a touch panel.

According to a preferred embodiment of the present invention, the camera detects the customers to operate the interactive panel. The arithmetic unit can detect focuses of the eyes of the customers, and convert the focuses into corresponding manipulation instructions. The corresponding manipulation instructions then are transmitted to the control unit coupled to the display device.

According to a preferred embodiment of the present invention, the control unit receives the corresponding manipulation instructions outputted by the arithmetic unit, converts the corresponding manipulation instructions into a variety of information required by the customers, and displays the information on the interactive panel.

According to a preferred embodiment of the present invention, the control unit can have a recorder for recording and filing the demands of the customers.

### BRIEF DESCRIPTION OF THE DRAWINGS

FIG. 1 is a block diagram of a customer serving system according to an embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

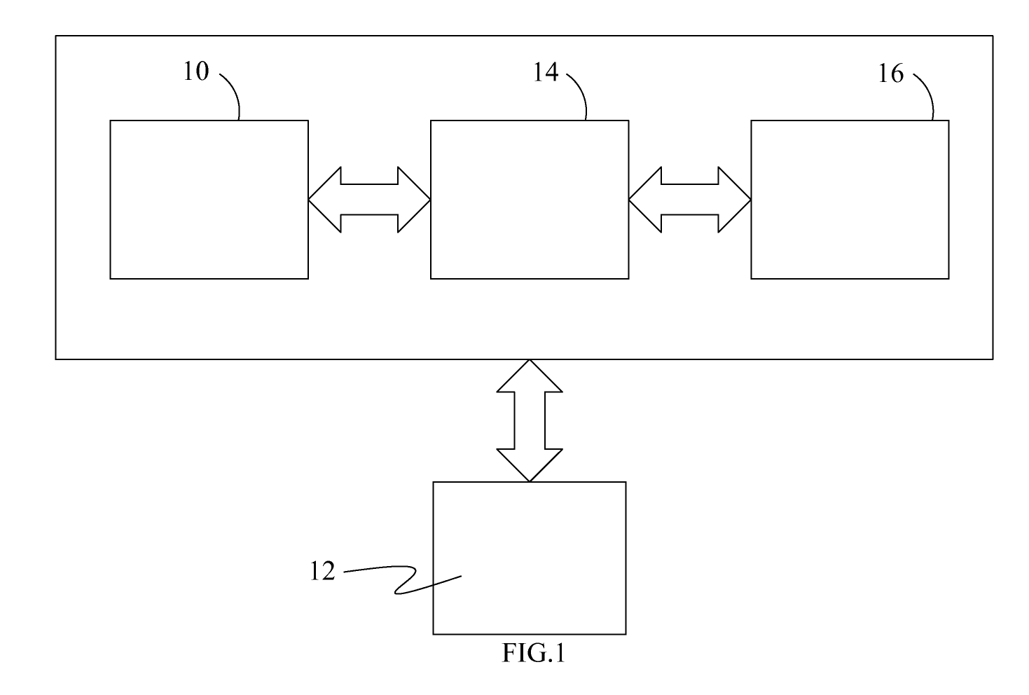

With reference to FIG. 1 for a customer serving system in accordance with a preferred embodiment of the present invention, the system mainly comprises a detection device 10, a display device 12, an arithmetic unit 14, and a control unit 16.

The detection device 10 can detect customers near counters by utilizing a sensor. Alternatively, the detection device 10 utilizes a camera to detect the customers, which come to the counters, within a monitoring area through a combination of the background recognition and object tracking technique.

In the embodiment, the detection device 10 applying the background recognition and object tracking can include a charged coupled device (CCD) camera. The CCD camera is utilized to capture images near the counters within the monitoring area. These images are continuously captured, and then transmitted the captured images to the arithmetic unit 14 coupled thereto.

The arithmetic unit 14 detects that the customers get into the monitoring area and shown in the images within the monitoring area, and identifies dynamic objects and backgrounds from the captured images. After detecting the dynamic objects, the appearance of the customers is recognized in the dynamic objects based on the dynamic characteristics, and subsequently transmitted to the control unit 16 coupled to the arithmetic unit 14.

When the customers coming near the counters are detected, the control unit 16 can notify service personnel to come back to serve the customers in real time, and to actuate the display device 12 to display a greeting message. The display device 12 can include an interactive panel. After greeting the customers, different kinds of commercial messages and service screens, such as commodity introduction, image advertisement, operation screens for serving customers, daily updated exchange rate and promotion of major commodities, are displayed to provide expositions and entertainments for the customers while waiting.

Before the service personnel show up, the detection device 10 continuously detects whether there is any abnormal condition or not. For example, thievery may occur, or dangerous materials may be placed. The arithmetic unit 14 continuously detects and tracks within the monitoring area near the counters through the sensor or the CCD camera, and provides the corresponding determination and decision.

If the abnormal condition is detected and determined to probably cause threats and potential danger, the control unit 16 generates the alarm notification in real-time to notify the service personnel about the abnormal condition. Then, the present invention provides abnormal movement information of the customers, such that the fast determination and decision can be immediately made to deal with the abnormal condition, and the service personnel are reminded to pay attention to the situation. If there is no abnormal condition, the commercial messages and service screens are simultaneously displayed. If the customers have any question about commercial information and need additional elaboration, the demands of the customers can be confirmed, and the questions of the customers can be answered and handled via the interactive panel. The interactive panel may be a touch panel. Alternatively, the intentions of the customers can be detected by tracking the pupil positions, recognizing hand motions, and detecting attention of the customers through the detection device 10. The CCD camera is utilized to capture the images of the customers, such that the service personnel may interact with the customers on the basis of providing service and information.

In the present embodiment, the customers can look attentively at the interactive panel. When the eyes of the customers move in accordance with the contents displayed on the interactive panel, reflections of the contents may be shown on their eyes. The CCD camera continuously captures the images of the eyes, and then the continuous captured images are transmitted to the arithmetic unit 14. The arithmetic unit 14 detects the exercise state of the eyes to perform the image analysis through a server. The pupils shown in the eyes' images which are continuously captured can be recognized, thereby calculating the movement position of the pupils and the sizes of the pupils.

Afterward, the arithmetic unit 14 evaluates the area around the pupils shown on the eyes' images to compute and confirm the position on the display device 10 where the eyes look. The arithmetic unit 14 can detect the focuses of the eyes of the customers with respect to the movements and changes of eyeballs. The focuses then are converted into correspondingly corresponding manipulation instructions. Subsequently, the corresponding manipulation instructions are transmitted to the control unit 16 coupled to the arithmetic unit 14.

The control unit 16 receives the corresponding manipulation instructions outputted by the arithmetic unit 14, and converts them into additional expositions and introductions associated with various information required by the customers. The information is displayed on the interactive panel through the server. The control unit 16 can be equipped with a recorder for recording and filing additional information of the customers to conveniently provide subsequent customized services without consuming time.

Accordingly, by combining the background recognition with the technique for tracking objects and pupils, the present invention can greet the customers, when the service personnel are temporarily absent. The customers can be greeted through the monitoring and tracking analysis of the camera, and the demands of the customer can be effectively handled in real time. The customer serving system can be switched to allow the service personnel to serve the customers after the service personnel show up. In the counters of large scale hotels that provide services, customer serving service can be provided, when the service personnel are temporarily absent, or the customers are waiting or standing in a line as well.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A customer serving system comprising:
a detection device for detecting customers within a monitoring area;
a display device coupled to the detection device and started to display a greeting message while the customers within the monitoring area are detected, the display device comprising an interactive panel for confirming demands of the customers and handling questions after greeting the customers; and
a control unit coupled to the display device for displaying information on the interactive panel based on requests of the customers.

2. The customer serving system as recited in claim 1, wherein the detection device comprises a sensor for performing detection.

3. The customer serving system as recited in claim 1, wherein the detection device comprises a camera for continuously capturing images in the monitoring area.

4. The customer serving system as recited in claim 3, wherein the detection device further comprises an arithmetic unit coupled to the camera to detect the appearance of the customers shown on the captured images, and to identify features of the customers.

5. The customer serving system as recited in claim 1, wherein the interactive panel is a touch panel.

6. The customer serving system as recited in claim 4, wherein the camera detects eyes of the customers for controlling the interactive panel.

7. The customer serving system as recited in claim 6, wherein the arithmetic unit detects focuses of the eyes of the customers to convert the focuses into corresponding manipulation instructions and to transmit the corresponding manipulation instructions to the control unit coupled the display device.

8. The customer serving system as recited in claim 7, wherein the control unit receives the corresponding manipulation instructions outputted by the arithmetic unit, converts the corresponding manipulation instructions into various kinds of information required by the customers, and displays the information on the interactive panel.

9. The customer serving system as recited in claim 1, wherein the control unit comprises a recorder for recording and filing the demands of the customers.

10. A customer serving system comprising:
a camera device for continuously capturing images;
an arithmetic unit coupled to the camera device for detecting the appearance of the customers shown on the captured images; and
a control unit coupled to the arithmetic unit for warning service personnel to handle an abnormal condition based on the analysis and determination of the arithmetic unit, and for actuating a display device to display greeting messages and switching the camera device to capture eyes images of the customers to display information required by the customers on an interactive panel while the customers are coming.

11. The customer serving system as recited in claim 10, wherein the camera device continuously captures images in a monitoring area.

12. The customer serving system as recited in claim 11, wherein the arithmetic unit detects the customers, identifies features of the customers, and transmits the features to the control unit.

13. The customer serving system as recited in claim 12, wherein the camera device captures eyes of the customers for controlling the interactive panel.

14. The customer serving system as recited in claim 13, wherein the arithmetic unit detects focuses of the eyes of the customers to convert the focuses into corresponding manipulation instructions and transmit the corresponding manipulation instructions to the control unit.

15. The customer serving system as recited in claim 14, wherein the control unit receives the corresponding manipulation instructions outputted by the arithmetic unit, converts the corresponding manipulation instructions into different kinds of information required by the customers, and displays the information on the interactive panel.
